(19) United States
(12) Patent Application Publication
(10) Pub. No.: US 2024/0266080 A1
(43) Pub. Date: Aug. 8, 2024

(54) INTERLOCKING FUEL ASSEMBLY STRUCTURE FOR CORE REACTIVITY CONTROL

(71) Applicant: TerraPower, LLC, Bellevue, WA (US)

(72) Inventors: Tamas Liszkai, Bellevue, WA (US); Jason Brian Meng, Redmond, WA (US)

(21) Appl. No.: 18/531,636

(22) Filed: Dec. 6, 2023

Related U.S. Application Data
(60) Provisional application No. 63/443,685, filed on Feb. 6, 2023.

(51) Int. Cl. G21C 5/16; G21C 5/18; G21C 21/00

(52) U.S. Cl. CPC G21C 5/16; G21C 5/18; G21C 21/00

(57) ABSTRACT

A nuclear reactor core includes a plurality of core assemblies. The core assemblies have a cooperating structure formed at one or more load pads that mechanically couple the plurality of core assemblies together to limit relative motion between core assemblies in a kinematically determinate way. A shear key on one core assembly is configured to fit in a tab slot on an adjacent core assembly. Motion of one core assembly is transferred to a second core assembly and the core assemblies move together.

### GOVERNMENT LICENSE RIGHTS

This invention was made with government support under DOE Cooperative Agreement No. DE-NE0009054 awarded by the U.S. Department of Energy. The government has certain rights in the invention.

### BACKGROUND

In a sodium-cooled fast reactor (“SFR”), the main reactor components are a reactor vessel filled with a liquid sodium coolant and a reactor core. In some cases, a n SFR is a once-through fast reactor that runs on subcritical reload fuel that is bred up and burned in situ. The reactor core is immersed in the sodium pool in the reactor vessel.

The sodium coolant is used to remove the heat from the core. The sodium coolant flows through the core assemblies, some of which may be fuel assemblies, by entering a nozzle of the core assembly and flowing about the fuel pins within the core assemblies to remove heat therefrom. A guard vessel surrounds the reactor vessel to prevent loss of sodium coolant in case of an unlikely leak from the reactor vessel. The pumps circulate primary sodium coolant between the reactor core and intermediate heat exchangers located in the pool.

The core of a fast reactor typically includes closely packed hexagonal arrangement of core assemblies. As the core assemblies move closer together in a radial direction, the reactivity within the core increases and as the core assemblies more farther apart, the reactivity decreases. The reactivity within a fast reactor core can be very sensitive to relative movement between core assemblies. The reactivity feedback depends, in large part, on how the core assemblies are supported and restrained.

Relative movement between core assemblies comes from several sources, such as seismic events, core assembly bowing due to thermal gradients, irradiation creep, and void swelling. The core assemblies are exposed to both axial and radial temperature and neutron flux gradients. The temperature gradients initially cause the core assemblies to bow which can cause contact between adjacent core assemblies through contact points above the fuel region of the core. The contact forces create bending stresses in core assemblies. Thermal and irradiation creep tend to relax those stresses, thereby reducing the contact forces over time. At the same time, differential irradiation swelling due to the fast neutron flux gradient causes inelastic bowing that can increases the contact forces over time.

The relative movement between core assemblies can lead to inter-assembly interaction and variations in overall core reactivity. The complex interactions between assemblies may cause displacements that result in reactivity insertion during start-up and steady-state operations and off-normal conditions that impact reactor stability.

It would be advantageous to reduce the inter-assembly movement to encourage a more predictable core reactivity while allowing for efficient refueling and shuffling of core assemblies. These, and other advantages and benefits, will become apparent to those of ordinary skill in the art by the figures and description that follow.

### SUMMARY

According to some embodiments, a hexagonal load pad for a nuclear core assembly includes a key extending from a first face of the hexagonal load pad, the key having a pair of key sidewalls extending away from the first face and a key face, the key face being generally parallel to the first face; and a slot formed on a second face of the hexagonal load pad, the slot configured with a pair of slot sidewalls configured to cooperate with the key to transfer motion from a first nuclear core assembly to a second nuclear core assembly.

In some cases, the pair of key sidewalls extend away from the first face at an obtuse angle. For example, a top view of the key in cross-section may resemble a trapezoid or a trapezoidal key. However, in some cases, a top view of the key in cross-section may resemble a rectangle or a square.

In some examples, the load pad is hexagonal in cross section and further includes three keys and three slots formed on alternating faces of the load pad. A second hexagonal load pad may also have one or more keys and slots, wherein one of the second hexagonal slots is configured to engage with the key extending from the first face. In other words, in some cases, the key is sized and shape to fit within the slot.

The load pad may be an above core load pad positioned on a core assembly duct at a location that is above a core of a nuclear reactor, and may additionally or alternatively be a top load pad located near an upper end of a core assembly duct.

According to some embodiments, a method for limiting relative movement between fuel assemblies within a core of a nuclear reactor includes the steps of forming two or more core assemblies having one or more of a top load pad and an above core load pad, the core assemblies having a multi-faced cross section; forming, on a first face of each of the core assemblies, a protruding key; forming, on a second face of each of the core assemblies, a groove configured to receive the key; and positioning two or more of the core assemblies adjacent to one another such that the protruding key from a first core assembly fits within the groove on a second core assembly. The key and groove may limit relative horizontal movement while allowing relative vertical movement between adjacent core assemblies.

In some examples, forming the two or more core assemblies further comprises forming the protruding key and the groove on alternating faces of the core assemblies, such as, for example, wherein the core assemblies have six faces and are formed with three keys and three grooves.

In some instances, the protruding key is formed by additive manufacturing, such as, for example, welding, printing, extruding, adhering, or some other suitable process for adding material to the core assembly face.

In some embodiments, linear motion of the first core assembly results in corresponding linear motion of one or more adjacent core assemblies. In other words, motion of one core assembly transfers a load to surrounding core assemblies that results in a similar motion of the surrounding core assemblies. In this way, the core assemblies may be locked together such that the assemblies move together while still be allowed to be removed and inserted individually into and out of the core, as desired.

According to some implementations, a nuclear core restraint system includes a first core assembly having a first mechanical key, the first core assembly formed as an elongate structure with a longitudinal axis and having a radius; and a second core assembly having a second mechanical key, the second mechanical key configured to engage with the first mechanical key to inhibit relative motion between the first core assembly and the second core assembly; and wherein radial movement of the first core assembly causes radial movement of the second core assembly.

The nuclear core restraint system may be configured such that the first mechanical key and the second mechanical key do not inhibit relative vertical movement of the first core assembly and the second core assembly. That is, a core assembly is free to be withdrawn or inserted in a vertical direction along the core assembly's longitudinal axis.

In some examples, the first mechanical key is a protrusion, and the second mechanical key is a slot configured to capture the protrusion. Of course, other geometries are possible for the first and second mechanical keys, as described in embodiments throughout this disclosure.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates, in a block diagram form, some of the basic components of a sodium-cooled fast reactor, in accordance with some embodiments.

FIG. 2 is a schematic sectional view of a core of a sodium-cooled fast reactor, in accordance with some embodiments.

FIG. 3 is a top sectional view of a reactor core of a nuclear fission reactor, in accordance with some embodiments.

FIG. 4 is an enlarged sectional view of fuel assemblies and a core support structure, in accordance with some embodiments.

FIG. 5 is a perspective view of a core assembly duct, in accordance with some embodiments.

FIGS. 6A and 6B are views of a core support structure and expected core assembly deformations, respectively, in accordance with some embodiments.

FIG. 7 is a block diagram illustrating core assembly kinematics, in accordance with some embodiments.

FIG. 8 illustrates a load pad of a core assembly with a shear key and slot tabs, in accordance with some embodiments.

FIG. 9 illustrates an interface between shear keys and shear tabs of adjacent core assemblies, in accordance with some embodiments;

FIG. 10 illustrates load pads of a plurality of core assemblies positioned adjacent one another, such as in a core; in accordance with some embodiments.

FIG. 11 is a block diagram illustrating core assembly kinematics when incorporating shear key and slot tabs, in accordance with some embodiments.

FIGS. 12A and 12B illustrate an alternative geometric configuration for shear key and shear tabs, respectively, in accordance with some embodiments.

FIG. 13 illustrates load pads of a plurality of core assemblies positioned adjacent one another, such as in a core, in accordance with some embodiments.

FIG. 14 is a plan view illustrating a geometric configuration of shear keys and slot tabs, in accordance with some embodiments.

FIG. 15 is a plan view illustrating a geometric configuration for inhibiting relative motion between adjacent fuel assemblies, in accordance with some embodiments.

FIG. 16 is a plan view illustrating a geometric configuration for inhibiting relative motion between adjacent fuel assemblies, in accordance with some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

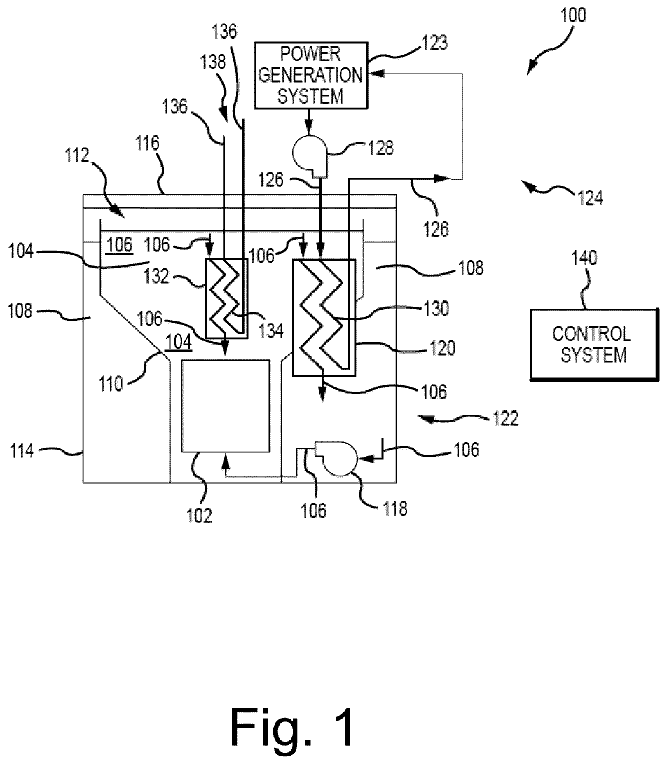

FIG. 1 illustrates, in a block diagram form, some of the basic components of a sodium-cooled fast reactor (SFR) 100. While an SFR may be used through the description as an example type of reactor technology, it should be appreciated that the concepts presented herein may be equally applicable to other types of reactors. In some cases, the concepts presented in the following description are directly appliable to other forms of sodium-cooled fast reactors (SFRs), such as, for example, traveling wave reactors, modular reactors, micro reactors, among others. Furthermore, the concepts presented herein may also be applicable to other reactor types, such as, without limitation, thermal reactors, water, chloride, or gas cooled reactors, as well as alternative fueled reactors, and the disclosure and appended claims should not be limited to any specific nuclear reactor, fuel source, coolant type, or reactor architecture.

In general, an SFR fission plant 100 includes a reactor core 102 containing a plurality of fuel assemblies (not shown). The core 102 is disposed within a pool 104 holding a volume of liquid sodium coolant 106. The pool 104 is referred to as a hot pool and has a sodium temperature higher than that of a surrounding cold pool 108 (due to the energy generated by the fuel assemblies in the reactor core 102), which also contains liquid sodium coolant 106. The hot pool 104 is separated from the cold pool 108 by the redan 110. A headspace 112 above the level of the sodium coolant 106 is filled with an inert cover gas, such as argon. The reactor vessel 114 surrounds the reactor core 102, hot pool 104, and cold pool 108, and is sealed with a reactor head 116. The reactor head 116 provides various access points into the interior of the reactor vessel 114.

The size of the reactor core 102 is selected based on a number of factors, including the characteristics of the fuel, desired power generation, available reactor 100 space, and so on. Various examples of an SFR fission plant may be used in low power (around 300 MWe—around 500 MWe), medium power (around 500 MWe—around 1000 MWe), and high power (around 1000 MWe and above) applications, as required or desired. The performance of the reactor 100 may be improved by providing one or more reflectors, not shown, around the core 102 to reflect neutrons back into the core 102. Additionally, fertile and fissile nuclear assemblies may be moved (or “shuffled”) within and about the core 102 to control the nuclear reaction occurring therein.

The sodium coolant 106 is circulated within the vessel 114 via a primary sodium coolant pump 118. The primary coolant pump 118 draws sodium coolant 106 from the cold pool 108 and injects it into a plenum below the reactor core 102. The coolant 106 is forced upward through the core and is heated due to the reactions taking place within the reactor core 102. Heated coolant 106 enters an intermediate heat exchanger(s) 120 from the hot pool 104 and exits the intermediate heat exchanger 120 and re-enters the cold pool 108. This primary coolant loop 122 thus circulates sodium coolant 106 entirely within the reactor vessel 114.

The intermediate heat exchanger 120 incorporates a segment of a closed liquid sodium loop that may be physically separated from the primary sodium pools 104 and 108 at all times (i.e., intermediate and primary sodium are never co-mingled). The intermediate heat exchanger 120 transfers heat from the primary coolant loop 122 (fully contained within the vessel 114) to an intermediate coolant loop 124 (that is only partially located within the vessel 114). The intermediate heat exchanger 120 passes through the redan 110, thus bridging the hot pool 104 and the cold pool 108 (so as to allow flow of sodium 106 in the primary coolant loop 122 therebetween). In an example, four intermediate heat exchangers 120 are distributed within the vessel 114. Alternatively, two or six intermediate heat exchangers 120 are distributed within the vessel 114. Of course, any suitable number of heat exchangers 120 may located within the vessel 114.

The intermediate coolant loop 124 circulates sodium coolant 126 that passes through pipes into and out of the vessel 114, via the reactor head 116. An intermediate sodium pump 128 located outside of the reactor vessel 114 circulates the sodium coolant 126 to a power generation system 123. Heat is transferred from the sodium coolant 106 of the primary coolant loop 122 to the sodium coolant 126 of the intermediate coolant loop 124 in the intermediate heat exchanger 120. The sodium coolant 126 of the intermediate coolant loop 124 passes through a plurality of tubes 130 within the intermediate heat exchanger 120. These tubes 130 keep separate the sodium coolant 106 of the primary coolant loop 122 from the sodium coolant 126 of the intermediate coolant loop 124, while transferring heat energy therebetween.

A direct heat exchanger 132 extends into the hot pool 104 and provides cooling to the sodium coolant 106 within the primary coolant loop 122, usually in case of emergency. The direct heat exchanger 132 is configured to allow sodium coolant 106 to enter and exit the heat exchanger 132 from the hot pool 104. The direct heat exchanger 132 has a similar construction to the intermediate heat exchanger 120, where tubes 134 keep separate the NaK (Sodium-Potassium) of the primary coolant loop 122 from the direct heat exchanger coolant (NaK) 136 of a direct reactor coolant loop 138, while transferring heat energy therebetween.

Other ancillary reactor components (both within and outside of the reactor vessel 114) include, but are not limited to, pumps, check valves, shutoff valves, flanges, drain tanks, etc., that are not depicted but would be apparent to a person of skill in the art. Additional penetrations through the reactor head 116 (e.g., a port for the primary coolant pump 118, inert cover gas and inspection ports, sodium processing, and cover gas ports, etc.) are not depicted. A control system 140 may be utilized to control and monitor the various components and systems which make up the reactor 100.

Broadly speaking, this disclosure describes configurations that improve the performance of the reactor 100 described in FIG. 1. Specifically, examples, configurations, and arrangements of core assembly supports provide for a more consistent and stable reactivity by reducing or eliminating relative movement between core assemblies. That is, embodiments described herein are configured to limit relative horizontal movement between adjacent core assemblies, while allowing individual core assemblies to be inserted or removed from the reactor core through vertical displacement.

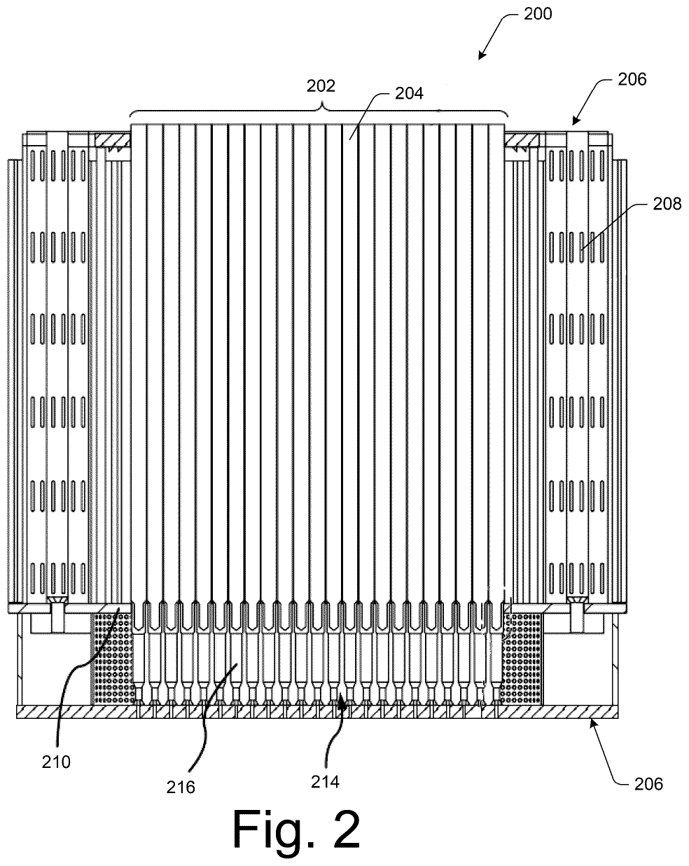

FIG. 2 is a schematic sectional view of a core 200 of an SFR. The core 200 is schematically shown and includes a central core region 202 having a plurality of core assemblies 204. The core assemblies 204 may include fissile nuclear fuel assemblies, fertile nuclear fuel assemblies, shield assemblies, reflector assemblies, control assemblies, and standby shutdown assemblies, or material testing assemblies. In general, the contents of the assemblies (e.g., fissile material, control material, etc.) identifies the particular assembly. The components of the assemblies that hold such material may be identical and interchangeable at locations within the reactor core. A peripheral core region 206 may include in-vessel storage pots 208. Throughout the life of the core 200, the fissile nuclear fuel assemblies and fertile nuclear fuel assemblies (as well as certain other assemblies) may be shuffled between the central core region 202 and the peripheral core region 206. This is performed at various stages of core life as required or desired to initiate, maintain, accelerate, or terminate nuclear reactions or power generation and/or for safety reasons.

The core assemblies 204 are received by an upper plate 210 of a core support structure 212 at locations aligned with a masking element 216. Sodium coolant is pumped into a plenum 214 disposed below the upper plate 210 and flows upward into the core assemblies 204 where it is heated by the nuclear reactions taking place within the core 200.

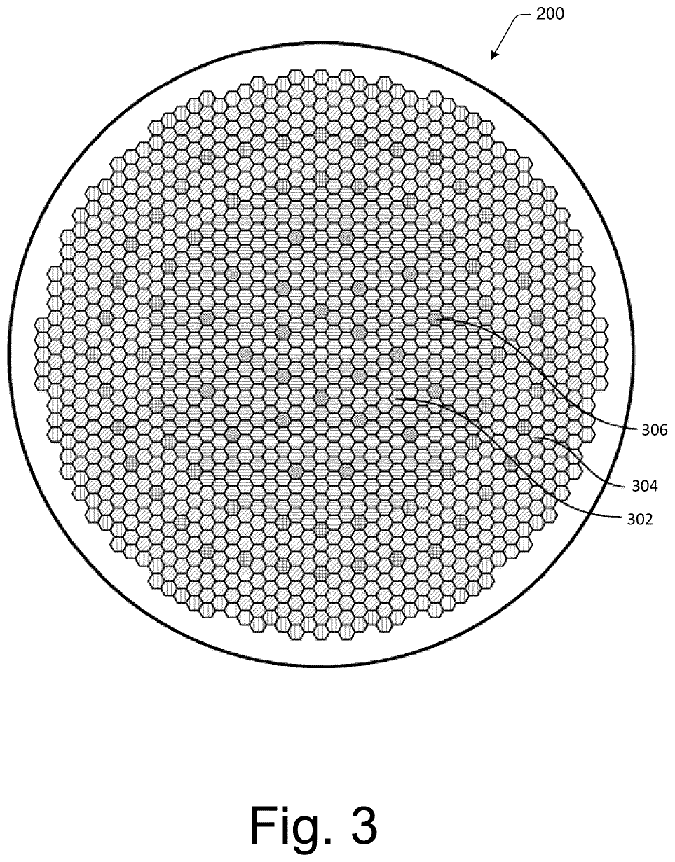

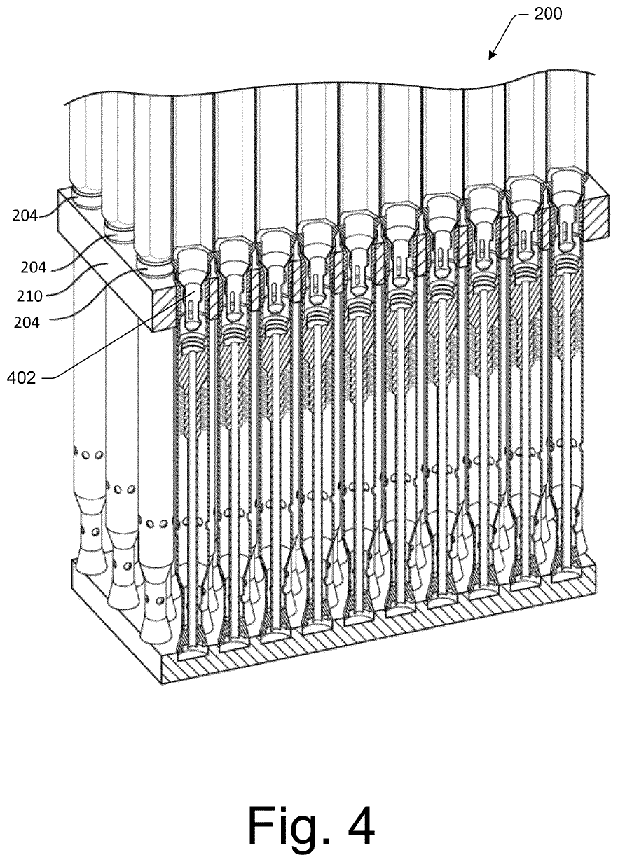

FIGS. 3 and 4 illustrate a nuclear fission reactor core 200 that includes a plurality of nuclear fuel assemblies (e.g., fissile nuclear fuel assemblies 302, fertile nuclear fuel assemblies 304, movable reactivity control assemblies 306, etc.), shown as core assemblies 204. As used throughout this description, the terms core assemblies and fuel assemblies may be used interchangeably, and relate to any assembly that is or may be positioned in the core whether having a type of fuel, reactivity control material, or otherwise. Similarly, the terms “core assembly duct” and “fuel assembly duct” may be used interchangeably to describe a duct that may be used with a fuel assembly or a core assembly. In many cases, a fuel assembly duct and a core assembly duct are identical in size and shape and may be inserted at any suitable location with the core.

In some embodiments, fuel assemblies 204 may be supported in part by a core support grid plate 210. The core support grid plate 210 may engage with a nozzle of the fuel assembly 204 to provide support at the lower end of the fuel assembly 204. Primary sodium coolant flows through fuel assemblies 204, according to some embodiments to absorb heat generated by fuel within the fuel assemblies undergoing fission reactions.

In some embodiments, fuel assembly 204 includes a plurality of nuclear fuel pins (e.g., fuel rods, fuel elements, etc.), disposed within a duct that includes a tubular body. In some cases, the tubular body has a hexagonal cross-sectional shape as shown in FIGS. 3 and 4. In use, the primary sodium coolant flows upwardly into the fuel assemblies 204 and around the fuel elements therein and draws heat away from the fuel assemblies and to the heat exchangers.

According to some embodiments, the fuel assemblies 204 are cantilevered in that they are secured in an aperture in the grid plate 210 by a nozzle 402 that forms a part of the fuel assembly 204. The remaining length of the fuel assembly may be largely unsupported. However, in some cases, an above core ring and/or a top ring may provide apertures that provide lateral support to the fuel assemblies once the fuel assemblies deform a sufficient distance to contact the upper support plate. In other words, the fuel assemblies may not be restrained at a location above the nozzle so that they are allowed to deform.

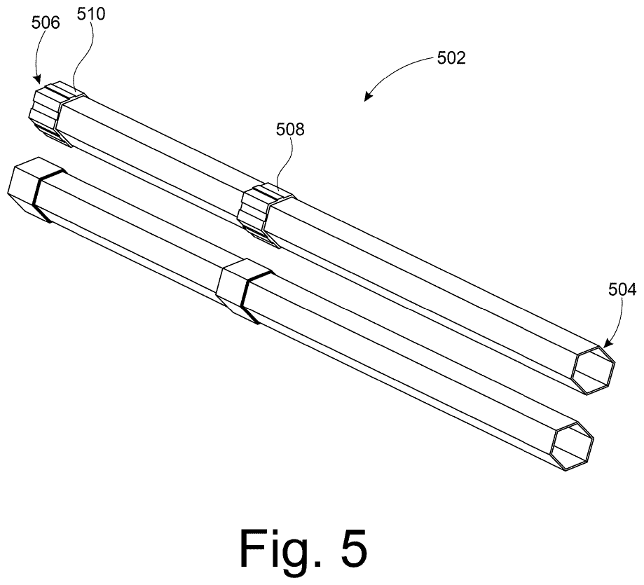

FIG. 5 illustrates an example of a duct 502 that may be used with a fuel assembly 204. In some embodiments, the duct 502 is a hollow tube that may be hexagonal in cross section. The hexagonal cross section allows a plurality of ducts to be packed into the core in an efficient packing technique, as illustrated in FIG. 3, such as a hexagonal array. The duct 502 may be filled with a bundle of fissile or fertile fuel elements, neutron reflectors, neutron absorbers, or other material. The duct 502 has a lower end 504 that may be coupled to a nozzle and an upper end 506. Disposed along the length of the duct may be an above core load pad 508 and/or a top load pad 510. The above core load pad 508 may be positioned such that the above core load pad 508 is adjacent to an above core load pad (ACLP) ring within the core that defines a lateral boundary around the fuel assemblies within the core. Similarly, the top load pad 510 may be positioned along the duct 502 such that the top load pad (TLP) 510 is adjacent to a top load pad ring within the core that defines a second lateral boundary around the fuel assemblies within the core. In some cases, an ACLP ring and/or a TLP ring may be positioned around the core and the arrangement of fuel assemblies to provide an annular constraint to the bundle of fuel assemblies, but may not necessarily constrain each fuel assembly individually. In use, as the fuel assemblies begin to deform, such as by bowing, the outermost fuel assemblies may eventually contact one or more of the ACLP ring or the TLP ring.

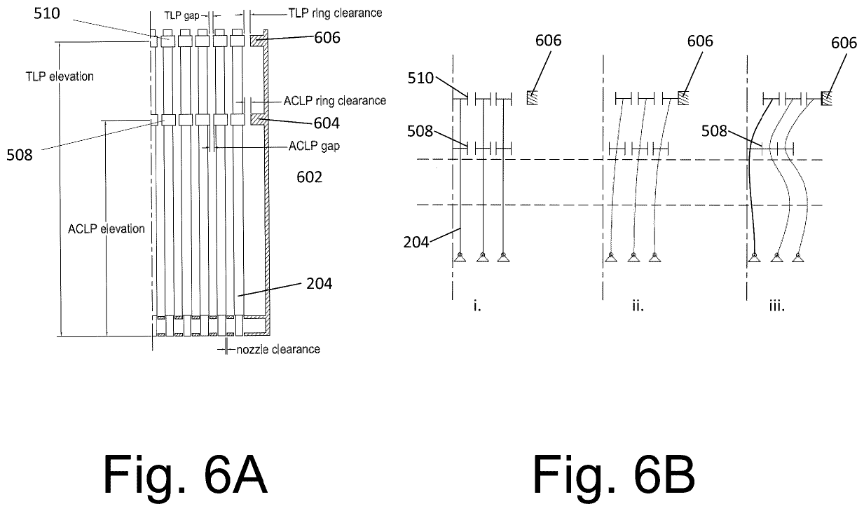

FIGS. 6A and 6B illustrate mechanical core design elements and notional deformation. Core assembly deformations are driven by various phenomena causing inter-assembly interactions (e.g., contact between adjacent assemblies) due to the design of the gaps between adjacent ACLPs 508 and TLPs 510. The movement of the fuel assemblies 204 relative to each other is largely driven by thermal and flux gradients, inter-assembly contact, contact with core support structures, and seismic excitation. In addition, over its lifetime fuel assemblies 204 undergo inelastic deformations due to the thermal and irradiation creep and void swelling. The complex interactions between assemblies may cause displacements that result in reactivity insertion during start-up, steady-state and transient operations which impact reactor stability.

Many SFRs rely on ACLPs 508 and TLPs 510 to achieve a Limited Free Bow (LFB) configuration that is designed to limit reactivity insertion (e.g., the changing of reactivity due to relative movement between fuel assemblies). FIGS. 6A and 6B illustrate a series of hexagonal fuel assemblies in a reactor core. The bottom portion of the fuel assemblies 204 is constrained at the nozzle. Above the core region is the portion of the fuel duct having the ACLP 508 located at an ACLP elevation. The ACLP is configured to maintain an ACLP gap 602 between adjacent fuel assemblies as they start to deform and provides preferential contact points between fuel assemblies 204.

The core restraint system shown further includes an ACLP ring 604 and a TLP ring 606. The core restraint system is configured for several important functions: to control the radial position of the core and maintain alignment between core components; limit motion of the fuel assemblies during seismic events; and provide a limit on fuel assembly bowing such that a negative reactivity feedback occurs in an over-power transient event.

The thermal and irradiation creep strain causes the fuel assemblies to deform, initially in a bowing direction, and may ultimately cause the fuel assemblies to take on 2^{nd} and 3^{rd} order deformations. This inelastic bowing results in residual contact forces between assemblies and can cause difficulties during refueling due to friction effects and additional loading forces. In a typical shuffling or refueling operation, individual core assemblies may be removed vertically from the core and either replaced, repositioned, or reinserted. Thus, the core assemblies should be able to move vertically, despite being constrained radially (e.g., horizontally).

Temperature changes in the core during power up and power down events tend to cause nonuniform thermal gradients in both axial and radial directions throughout the core. The thermal gradients can introduce bending effects to the fuel assemblies, as further shown in FIG. 6B. The core restraint system provides protection against overpower events by taking advantage of, and limiting, thermally induced bending of the fuel assemblies. As shown in (i), a row of three fuel assembles are located radially away from the center of a reactor core. As a thermal gradient increases, as shown in (ii.), and the thermal gradient introduces higher temperatures nearer to the center of the reactor core, the fuel assemblies begin to bow outward away from the center of the reactor core, which therefore reduces the reactivity. As shown in (iii.), once the outermost fuel assemblies contact the TLP ring 606, the temperature gradient increases and the center of the fuel assembly 204 bows inward which increases reactivity. As the temperature gradient increases due to the increased reactivity, the inward bowing continues until the fuel assemblies contact adjacent fuel assemblies at their respective ACLPs 508. When the fuel assemblies 204 contact one another, no further compaction can occur, and the reactor is considered locked up. While an example core restraint system is shown, the descriptions herein apply equally to other core restraint systems. For example, the solutions to relative motion between core assemblies described herein may be applied to any type of core restraint system and with any type of nuclear reactor.

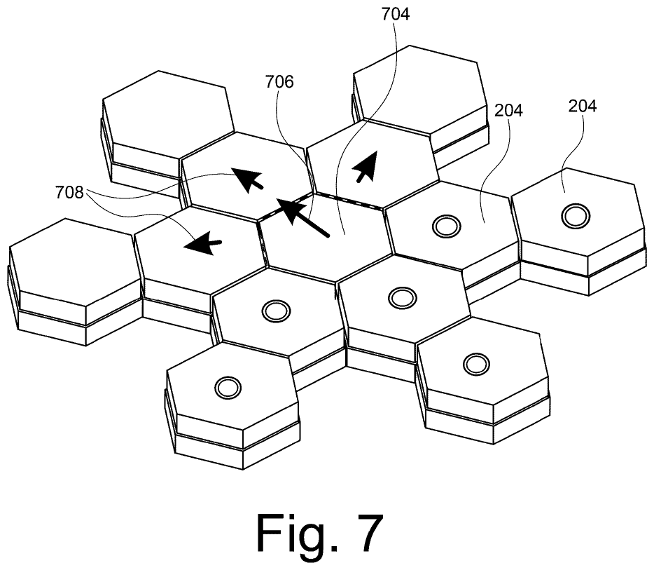

As further illustrated in FIG. 7, which illustrates the kinematics of prior core restraint systems. A series of hexagonal fuel assemblies 204 are shown arranged in a core in a hexagonal close packing configuration. It should be noted that while the Figure shows load pads, the load pads are each associated with core assemblies. Therefore, motion of the load pad indicates motion of the core assembly. In some cases, a dimpled face is provided on each of the 6 faces of the ACLP and the TLP to provide preferential contact points between adjacent fuel assemblies and to maintain an appropriate gap between adjacent fuel assemblies. Contact between adjacent fuel assemblies happens at the ACLP and/or the TLP (together, the “load pads”) and the contact imparts a force that is normal to the surface. For example, where the center-most fuel assembly 704 moves in the direction indicated by the arrow 706, the gap between adjacent fuel assemblies will be closed and contact occurs at the faces of the ACLP and TLP. As a result, adjacent assemblies move in the direction normal to the contact interfaces as indicated by small arrows 708. The fuel assemblies 204 marked with a circle remain stationary and the overall gap increases between the stationary and the moving fuel assemblies. The fuel assemblies that move together close the contact along multiple rows resulting in a compaction and the remaining fuel assemblies located in a direction opposite the movement are decoupled and the spacing increases, while reactivity decreases.

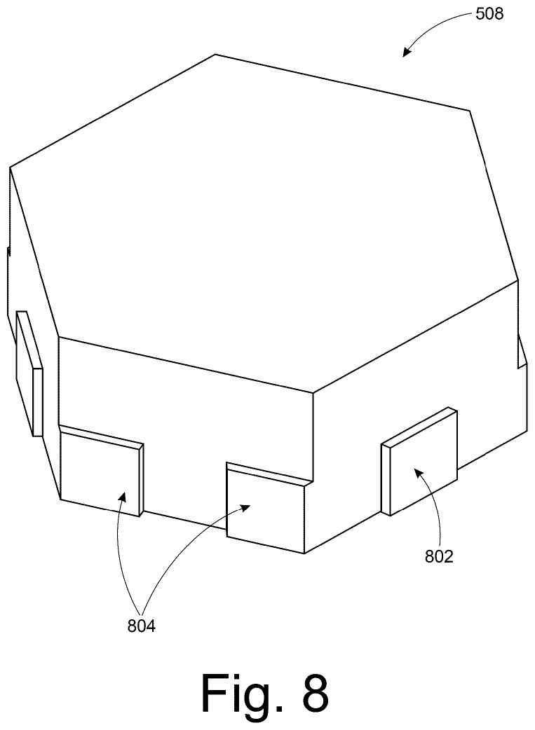

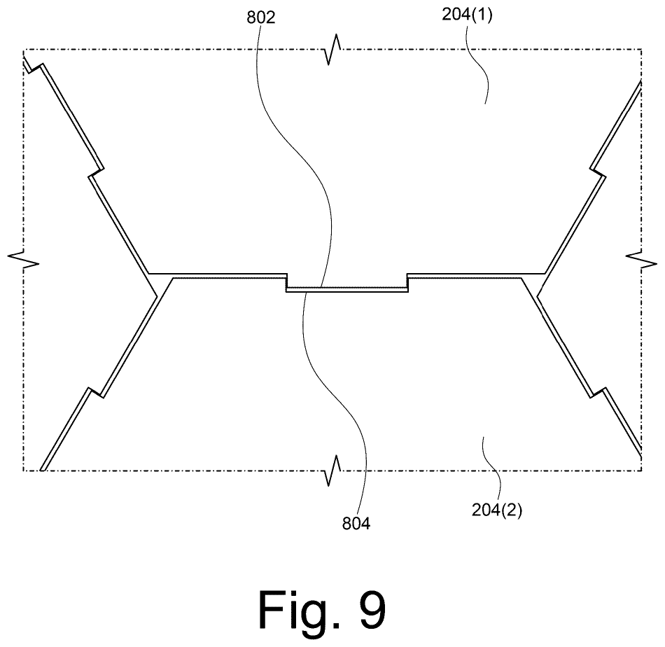

FIG. 8 illustrates an example embodiment showing hexa-shear keys that may be formed into the faces of one or more of the ACLP 508 or TLP. For efficiency, the figure illustrates a perspective view of a single load pad; however, it should be understood that the illustrated load pad forms a part of a core assembly, and in many cases, there are two load pads associated with each core assembly. The hexa-shear key may include a shear key 802 and a cooperating slot tab 804 formed into alternating faces of the ACLP. In embodiments that utilize hexagonal fuel ducts, the faces of the ACLP 508 and TLP 510 may include 3 shear keys 802 and 3 slot tabs 804. With additional reference to FIG. 9, the interfaces between load pads associated with adjacent fuel assemblies 204 are shown. The fuel assemblies are arranged within the core such that a shear key 802 on a first fuel assembly 204(1) may contact, and fits within, a slot tab 804 on an adjacent fuel assembly 204(2). In some embodiments, the single tabs on alternating faces of the TLP and ACLP are the shear keys 802 and the dual tabs on the other alternating faces of the TLP and ACLP form the slot tabs 804. The interface between adjacent fuel assemblies may have a designed interface tolerance such that the width of the shear key 802 in relation to the slot tab 804 is much smaller than the spacing between adjacent fuel assemblies 204. The load transfer between adjacent fuel assemblies becomes tangential to the respective faces of the fuel assemblies as opposed to the imparted force being normal to the fuel assembly face (as in FIG. 7). Consequently, when a first fuel assembly 204(1) moves in a given direction, the interface with adjacent fuel assemblies causes the adjacent fuel assemblies to move in the same direction as the first fuel assembly 204(1). The moving fuel assembly is configured to push or pull adjacent fuel assemblies to move in the same direction.

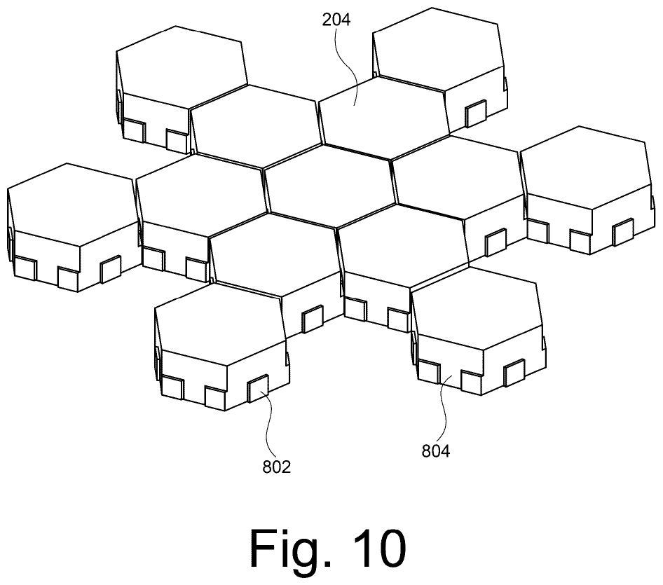

FIG. 10 illustrates a plurality of load pads associated with fuel assemblies 204 arranged with respective shear keys engaging with cooperating slot tabs of adjacent fuel assemblies. As can be seen, in a hexagonal fuel duct, three faces are configured with shear keys 802 that each engage three slot tabs 804 of adjacent fuel ducts. In this way, the fuel ducts (and the fuel assemblies) are mechanically keyed together. In some cases, the fuel assemblies are mechanically coupled together to encourage the relative motion of a first fuel duct to transfer a force to an adjacent fuel duct in a direction tangential to the interface between the adjacent fuel assemblies. In other words, where a first fuel duct has a first face that interacts with a second fuel duct having a second face, where the second face and the first face are parallel, a force transferred from the first fuel duct to the second fuel duct is parallel with the first face and second face. The force transfer may be accomplished through any suitable structure. In some cases, the structure is a mechanical keying structure on one or more of the first fuel duct and the second fuel duct, such as at the load pads. The mechanical keying structure on the first face may be different than the mechanical keying structure on the second face. For example, the mechanical keying structure on the first face may be a protrusion, a boss, a ridge, a key, a spline, a tooth, a gear, or some other structure, and the mechanical keying structure on the second face may be a pocket, a slot, a hole, a ridge, a protrusion, a groove, a gear or some other structure configured to cooperate with the mechanical keying structure on the first face.

In some cases, a fuel assembly will be formed with the first mechanical keying structure and the second mechanical keying structure, with the first mechanical keying structure and the second mechanical keying structure formed on alternating faces of a multi-faced fuel duct. In some embodiments, a fuel duct has a hexagonal cross section, and three faces include the first mechanical keying structure and the other three faces include the second mechanical keying structure. The cooperating mechanical keying structure may cause the load transfer from a first fuel duct to a second fuel duct to be tangential to the fuel assembly faces.

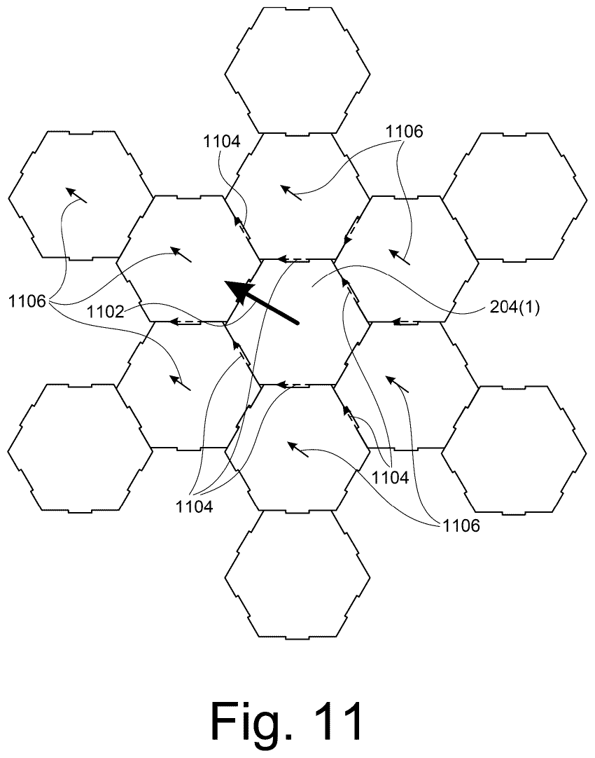

FIG. 11 illustrates a plurality of fuel assemblies having a cooperating mechanical keyed structure and further showing the kinematics of load transfer and motion of a fuel assembly. As illustrated, the fuel assemblies are keyed together and relative motion is constrained. When the central fuel assembly 204(1) moves in the direction indicated by the arrow 1102, the gaps at the shear keys 802 are closed, the forces on the adjacent fuel assemblies develop tangentially to the fuel assembly faces as shown by arrows 1104. Due to the interlocking of the shear keys with the slot tabs, the motion of the entire core is tied together. In other words, according to some embodiments, none of the fuel assemblies within the core can move independently. In some cases, the constrained kinematics forces all fuel assemblies to move in the same direction as the driving assembly as indicated by the arrows 1106. According to some embodiments, this arrangement will result in a mechanically locked core regardless of the nature of the motion (e.g., thermal, seismic, swelling, etc.). Thus, motion of one fuel assembly results in motion of all the fuel assemblies, and not just the fuel assemblies that are immediately adjacent to the fuel assembly in motion. The maximum displacement between any assemblies in the core is limited by the gap between the shear key and the slot tabs which may be much smaller than those in previous designs. In some cases, the shear key and the slot tabs may engage one another like teeth on meshed gears. For example, rotation of a first fuel assembly may tend to cause counter rotation of a second fuel assembly; however, with a plurality of fuel assemblies all engaging one another, any rotational forces will be resisted and instead linear motion is more likely to result. In effect, the plurality of fuel assemblies will behave as if they are locked together and allowed to move linearly as a mechanically linked assembly. However, relative vertical movement is largely unconstrained, and a single fuel assembly may be removed from the core in a vertical direction or inserted into the core in a vertical direction.

The inventors herein have demonstrated these techniques through advanced dynamic modeling and simulation and have observed that the fuel assemblies behave as if they are locked together and any relative motion is minimal.

According to some embodiments, the shear keys and slot tabs are configured to allow relative motion in a vertical direction, such as to facilitate loading the fuel assemblies into and out of the core, while constraining, or at least inhibiting, relative motion in a horizontal direction. As used herein, to inhibit relative motion in a horizontal direction is used to mean that not necessarily all relative motion is eliminated. For example, there may be a small amount of relative motion before the mechanical keyed structure of one fuel assembly engages with the keyed mechanical structure of an adjacent assembly. Therefore, the tolerances between the cooperating structures will allow some relative movement. However, relative movement between adjacent fuel assemblies is drastically reduced as compared with traditional configurations, and as described, all the fuel assemblies within the core behave as if they are locked together such that they move together, thus drastically reducing the relative motion between adjacent assemblies. The result is that the fuel assemblies each have a fixed distance between adjacent assemblies, even during motion caused by thermal gradients, seismic events, or swelling.

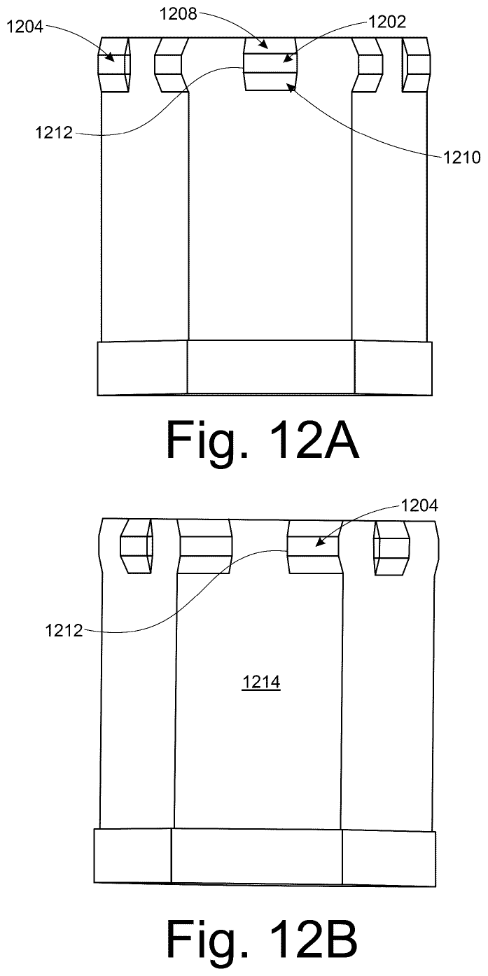

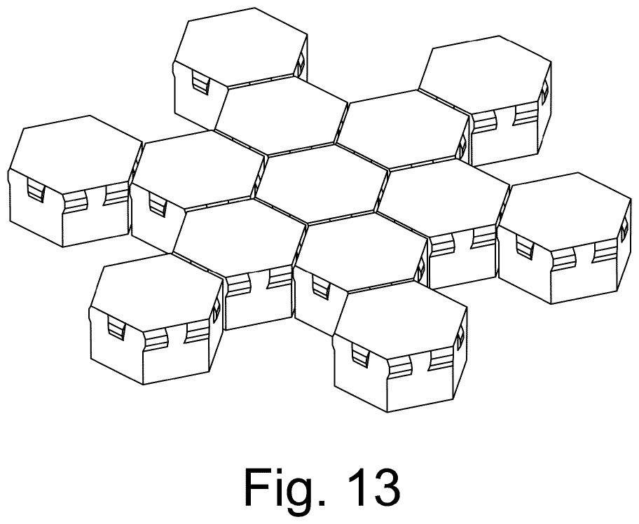

The specific geometry of the shear keys and slot tabs can be infinitely varied while still resulting in the advantages described herein. FIGS. 12A, 12B, and 13 illustrate some other such variations of the shear key 1202 and slot tab 1204 in accordance with some embodiments.

In some cases, an upper edge 1208 of the shear key 1202 and/or the slot tab 1204 may be chamfered, such as to encourage entry of the shear key 1202 into the slot tab 1204. Similarly, a lower edge 1210 of the shear key 1202 may also be chamfered to encourage the fitment of the shear key 1202 into the slot tab 1204. The shear key 1202 has a pair of sidewall faces 1212 that extend away from the fuel assembly a distance that defines how far the shear key extends away from the fuel assembly. In some cases, the sidewall faces 1212 are vertical and parallel with each other. Similarly, the slot tabs 1204 may have correspondingly oriented side wall faces 1214 that may likewise be vertical, which cooperate with the shear keys 1202 to transfer motion that in a direction that is perpendicular to the fuel assembly face 1214.

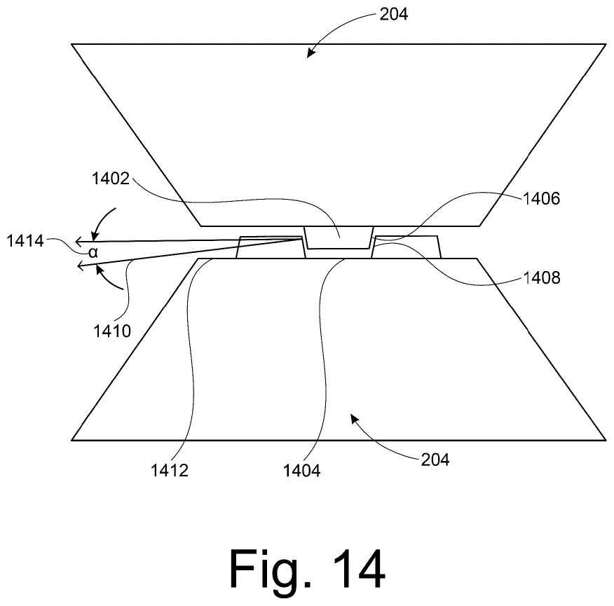

FIG. 14 illustrates a plan view of another geometric configuration of the shear key 1402 and slot tab 1404. In some cases, the shear key 1402 may have a sidewall 1406 that is angled with respect to the face of the ACLP and/or the TLP. As shown, the shear key 1402 may have a first surface that contacts the fuel assembly 204 having a first dimension and a second opposing surface spaced a distance away from the fuel assembly having a second dimension, wherein the second dimension is smaller than the first dimension. As shown, the shear key 1402 may become narrower as it extends away from the fuel assembly 204. Similarly, the slot tab 1404 may have a cooperating shape to receive the shear key 1402 in which the slot tab 1404 may widen as it extends away from the fuel assembly 204 in a radial direction. In such configurations, the sidewalls 1406, 1408 of the shear key 1402 and slot tab 1404 may be substantially vertical when the fuel assemblies are within the reactor core. The vertical sidewalls 1406, 1408 facilitate the vertical insertion or removal of one or more fuel assemblies 204 within the core.

In some cases, the clearance between the shear key sidewalls 1406 and tab slot sidewalls 1408 is smaller than the clearance between the respective faces of the fuel assemblies 204. In some cases, this allows the contact between adjacent fuel assemblies 204 to be located at the sidewalls of the shear key 1402 and tab slot 1404, which causes the load transfer from one fuel assembly to an adjacent fuel assembly to be normal to the surface of the shear key sidewall 1406 and the slot tab sidewall 1408. As such, the motion of one moving fuel assembly will pull the adjacent fuel assemblies in a same direction as the moving fuel assembly. This concept is further illustrated in FIG. 11, which applies equally to other shear key and slot tab geometries.

The faces of the shear key sidewall 1406 and slot tab sidewall 1408 of adjacent fuel assemblies 204 may be parallel to one another and may encourage surface contact between the shear key sidewall 1406 and slot tab sidewall 1408 as one or more of the fuel assemblies 204 moves. Contact between the shear key sidewall 1406 and slot tab sidewall 1408 of adjacent fuel assemblies may transfer a load from the shear key 1402 to the slot tab 1404, or vice versa. The vector 1410 of the load may have a direction that forms an acute angle α 1414 with respect to the face 1412 of the fuel assembly 204. Consequently, a load transfer from one fuel assembly to an adjacent fuel assembly may not have a tendency to push the adjacent fuel assembly away from the moving fuel assembly, but rather, the load transfer vector will pull an adjacent fuel assembly in the direction of movement of the moving fuel assembly.

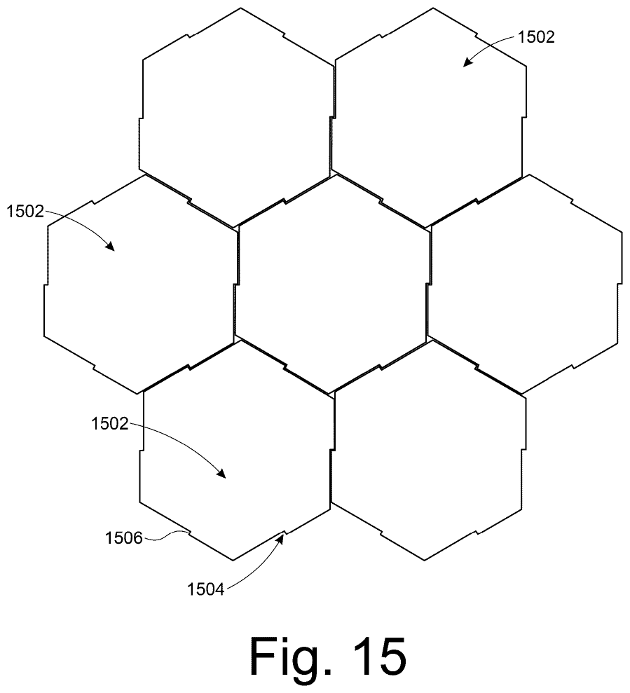

FIG. 15 illustrates another embodiment of a way to inhibit relative motion between adjacent fuel assemblies 204 while allowing vertical removal and insertion of a fuel assembly into a reactor core. As shown, a load pad 1502 can be configured with each of the six faces being identical, and may have a step 1504 formed therein. The step 1504 may 1504 may define a radially extending surface 1506 that interferes with a step 1504 on an adjacent fuel assembly load pad 1502. In some cases, the load pad 1502 has a generally hexagonal cross section and the six faces are formed identically in order to inhibit relative movement between adjacent fuel assemblies.

As with any embodiment herein, the cooperating structure may be formed into the load pad, such as by a material removal process. In some cases, the load pads may be machined to form the cooperating structures described herein. In some cases, the load pads may undergo additive manufacturing to add surface features to create the cooperating structures. As an example, additive manufacturing may include welding, adhering, printing, swaging, or other process that adds material to the load pad. In some cases, the cooperating structure may be formed during manufacture of the load pad, such as by extrusion, molding, casting, or otherwise. According to any of the embodiments described herein, the cooperating structure may utilize the same structural component, although may vary the number of structural components. For example, a single shear key may be added to a face of a load pad, and a cooperating load pad may have two shear keys spaced apart on a face of the load pad to create a tab slot for the single shear key to fit into.

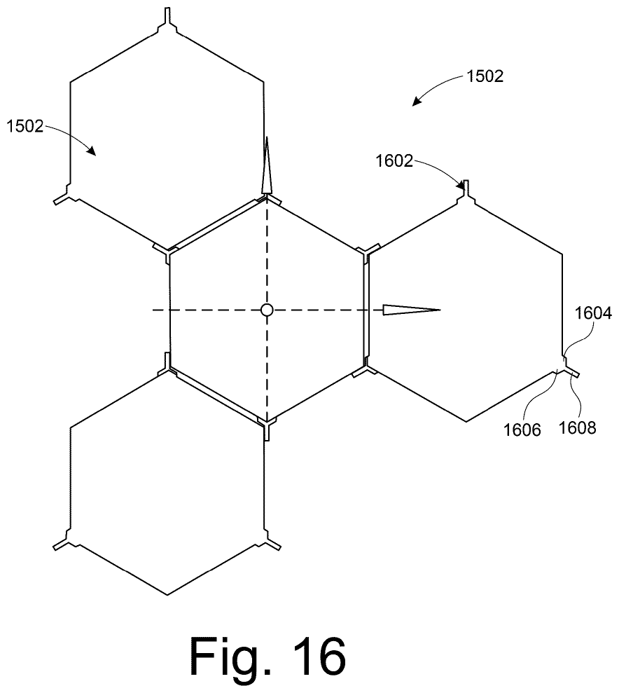

FIG. 16 illustrates a plan view of a plurality of load pads and another embodiment for inhibiting relative motion between adjacent fuel assemblies. As illustrated, a load pad 1502 may be configured with a key 1602 that is mounted at one or more of the corners of the load pad 1502. In some cases, the key 1602 is attached at three corners of a hexagonally shaped load pad 1502. As shown, the key 1602 may be attached at alternating corners of the load pad, such that a load pad 1502 may carry three keys 1602. The keys 1602 may be shaped to have three legs, two of which are attached to the load pad, 1604, 1606, and a third leg 1608 extends radially away from the load pad 1502. They keys 1602 provide a spacer between the load pad and adjacent load pads. Furthermore, the keys 1602, by virtue of their geometry and extending direction, may transfer a load caused by motion of one fuel assembly to an adjacent fuel assembly that pulls the adjacent fuel assembly in the same direction as the motion of the moving fuel assembly. In this way, the fuel assemblies may behave as if they are locked together when subjected to motion, although individual fuel assemblies are free to move in a vertical direction, such as for insertion or removal from the core.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of.” Finally, for ease of use, the terms “including” and “having” (and their derivatives), as used in the

The specification and annexed drawings disclose examples of systems, apparatus, devices, and techniques that may provide control and optimization of coolant flow through core assemblies. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A hexagonal load pad for a nuclear core assembly, comprising:
a key extending from a first face of the hexagonal load pad, the key having a pair of key sidewalls extending away from the first face and a key face, the key face being generally parallel to the first face; and
a slot formed on a second face of the hexagonal load pad, the slot configured with a pair of slot sidewalls configured to cooperate with the key to transfer motion from a first nuclear core assembly to a second nuclear core assembly.

2. The hexagonal load pad of claim 1, wherein the pair of key sidewalls extend away from the first face at an obtuse angle.

3. The hexagonal load pad of claim 1, wherein the load pad is hexagonal in cross section and further comprising three keys and three slots formed on alternating faces of the load pad.

4. The hexagonal load pad of claim 1, further comprising a second hexagonal load pad configured with one or more keys and slots, wherein one of the second hexagonal load pad slots is configured to engage with the key extending from the first face.

5. The hexagonal load pad of claim 1, wherein the load pad is an above core load pad positioned on a fuel duct at a location that is above a core of a nuclear reactor.

6. The hexagonal load pad of claim 1, wherein the load pad is a top load pad located near an upper end of a fuel duct.

7. The hexagonal load pad of claim 1, wherein a key on a first hexagonal load pad engages with a slot on a second adjacent hexagonal load pad to inhibit relative horizontal movement between the first hexabonal load pad and the second adjacent hexagonal load pad while allowing relative vertical movement between the first hexagonal load pad and the second hexagonal load pad.

8. A method for limiting relative movement between fuel assemblies within a core of a nuclear reactor, the method comprising:
forming two or more core assemblies having one or more of a top load pad and an above core load pad, the core assemblies having a multi-faced cross section;
forming, on a first face of each of the core assemblies, a protruding key;
forming, on a second face of each of the core assemblies, a groove configured to receive the protruding key; and
positioning two or more of the core assemblies adjacent to one another such that the protruding key from a first core assembly fits within the groove on a second core assembly.

9. The method of claim 8, wherein forming the two or more core assemblies further comprises forming the protruding key and the groove on alternating faces of the core assemblies.

10. The method of claim 9, wherein the core assemblies have six faces and are formed with three keys and three grooves.

11. The method of claim 8, wherein the protruding key is formed by additive manufacturing.

12. The method of claim 8, wherein linear motion of the first core assembly results in corresponding linear motion of one or more adjacent core assemblies.

13. The method of claim 12, wherein a load from the first core assembly is transferred through the protruding key of the first core assembly to a groove of a second core assembly.

14. The method of claim 13, wherein the key includes key sidewalls extending away from the core assembly and the groove includes groove sidewalls defining a depth of the groove, and the load is transferred from the key sidewalls to the groove sidewalls.

15. The method of claim 8, wherein movement of a first core assembly causes contact between the protruding key on the first core assembly and the groove on the second core assembly.

16. The method of claim 8, wherein the protruding key and grooves are configured to limit relative horizontal motion between adjacent core assemblies while allowing vertical motion between adjacent core assemblies.

17. The method of claim 8, wherein positioning two or more of the core assemblies adjacent one another further comprises locating seven or more core assemblies in a nuclear reactor in a hexagonal array such that the seven or more core assemblies each engage with adjacent core assemblies through corresponding keys and grooves.

18. A nuclear core restraint system, comprising:
a first core assembly having a first mechanical key, the first core assembly formed as an elongate structure with a longitudinal axis and having a radius; and
a second core assembly having a second mechanical key, the second mechanical key configured to engage with the first mechanical key to inhibit relative motion between the first core assembly and the second core assembly; and
wherein radial movement of the first core assembly causes radial movement of the second core assembly.

19. The nuclear core restraint system of claim 18, wherein the first mechanical key and the second mechanical key do not inhibit relative vertical movement of the first core assembly and the second core assembly.

20. The nuclear core restraint system of claim 18, wherein the first mechanical key is a protrusion and the second mechanical key is a slot configured to capture the protrusion.
